(19) United States
(12) Patent Application Publication
(10) Pub. No.: US 2024/0253739 A1
(43) Pub. Date: Aug. 1, 2024

(54) Braking Systems for Snowmobiles

(71) Applicant: Arctic Cat Inc., Thief River Falls, MN (US)

(72) Inventor: Samuel James Sandoz, Thief River Falls, MN (US)

(73) Assignee: Arctic Cat Inc., Thief River Falls, MN (US)

(21) Appl. No.: 18/411,902

(22) Filed: Jan. 12, 2024

Related U.S. Application Data
(60) Provisional application No. 63/441,551, filed on Jan. 27, 2023.

(51) Int. Cl. B62M 27/02; B60T 1/00

(52) U.S. Cl. CPC B62M 27/02; B60T 1/005

(57) ABSTRACT

A braking system for a snowmobile includes a track driveshaft and a splined spacer. The track driveshaft has an outer spline and is formed from a first material. The splined spacer has an inner spline and an outer spline. The inner spline of the splined spacer forms a splined connection with the outer spline of the track driveshaft such that the splined spacer is coaxially positioned about the track driveshaft. The outer spline of the splined spacer is configured to form a splined connection with an inner spline of a brake rotor. The splined spacer is formed from a second material that is different from the first material.

### CROSS-REFERENCE TO RELATED APPLICATIONS

The present application claims the benefit of U.S. Provisional Application No. 63/441,551, filed Jan. 27, 2023, the entire contents of which is hereby incorporated by reference.

### TECHNICAL FIELD OF THE DISCLOSURE

The present disclosure relates, in general, to braking systems for use in land vehicles such as snowmobiles and, in particular, to multi-material driveshaft assemblies having a hardened splined spacer configured for engagement with a floating brake rotor, as well as brake rotors with forged features to ensure constant and alternating engagement with a brake scrub area while minimizing machining cost.

### BACKGROUND

Snowmobiles are popular land vehicles used in cold and snowy weather conditions across a wide variety of transportation and recreational applications such as deep snow transit, luxury touring and trail riding. Many snowmobiles utilize a disc-and-caliper braking system to ensure safe and reliable braking during operation. Typically, in a disc-and-caliper braking system fluid pressure from a master cylinder drives caliper pistons onto brake pads, which clamp on a rotating brake rotor, thereby producing friction that slows a driveshaft. These existing disc-and-caliper braking systems are not unlike the disc brakes used on some automobiles. The driveshafts on which current disc-and-caliper braking systems act are often formed from aluminum. While aluminum driveshafts have certain weight advantages, aluminum driveshaft components that interface with the vehicle's braking system may exhibit greater wear, shorter lifespans and generally lower performance. Accordingly, a need has arisen for improved driveshafts that take advantage of lightweight materials such as aluminum while using harder materials for those components that interface with the braking system.

The brake rotor of a disc-and-caliper braking system can be a significant driver of weight and cost for the vehicle. Some current brake rotors are manufactured by first forging the initial shape of the brake rotor and then placing the brake rotor on a lathe or mill so that the brake rotor can be machined or trued up to eliminate wobble. To reduce weight, the brake rotor is then further machined to provide windows and indentations. Machining, however, is an inefficient and expensive process for reducing weight that can double or triple the manufacturing cost of the brake rotor. In addition, the windows or indentations on current brake rotors may lead to uneven wear or rocking of the brake pads that engage the brake rotor. Accordingly, a need has arisen for improved brake rotors that have indentations and other features to provide constant and alternating brake scrub area engagement with applied brake pads, reduced manufacturing cost of the brake rotor and improved wear profile of the brake pads.

### SUMMARY

In a first aspect, the present disclosure is directed to a braking system for a snowmobile. The braking system includes a track driveshaft and a splined spacer. The track driveshaft has an outer spline and is formed from a first material. The splined spacer has an inner spline and an outer spline. The inner spline of the splined spacer forms a splined connection with the outer spline of the track driveshaft such that the splined spacer is coaxially positioned about the track driveshaft. The outer spline of the splined spacer is configured to engage an inner spline of a brake rotor. The splined spacer is formed from a second material that is different from the first material.

In certain embodiments, the track driveshaft may have an annular shoulder that is positioned inboard of the outer spline of the track driveshaft and the splined spacer may have an annular socket positioned inboard of the inner spline of the splined spacer such that the annular socket of the splined spacer may be received by the annular shoulder of the track driveshaft. In such embodiments, the annular socket of the splined spacer and the annular shoulder of the track driveshaft may have a close fitting relationship. In some embodiments, the splined spacer may have an axial length X, the inner spline of the splined spacer may have an axial length Y and the annular socket of the splined spacer may have an axial length Z wherein, Y<X, Z<X and Z<Y. In certain embodiments, the track driveshaft may have external threads positioned outboard of the outer spline of the track driveshaft that form a threaded connection with internal threads of an annular nut such that the annular nut prevents axial movement of the splined spacer relative to the track driveshaft. In other embodiments, the track driveshaft may have internal threads positioned inboard of the outer spline of the track driveshaft that form a threaded connection with external threads of an annular nut such that the annular nut prevents axial movement of the splined spacer relative to the track driveshaft. In such embodiments, the annular nut may have a head and a shaft wherein, the shaft includes the external threads and is received inside the track driveshaft and the head is positioned outboard of the track driveshaft and in contact with the splined spacer.

In some embodiments, the track driveshaft may have a radially reduced external section positioned between the outer spline of the track driveshaft and the annular shoulder of the track driveshaft. In such embodiments, the internal threads of the track driveshaft may be positioned inboard of the radially reduced external section of the track driveshaft. In certain embodiments, the second material may have a higher hardness than the first material. For example, the first material may be aluminum and the second material may be steel. In some embodiments, the braking system may include an annular sleeve formed from a third material, the track driveshaft may have an annular ridge positioned inboard of the annular shoulder of the track driveshaft and the annular sleeve may be coaxially positioned about the track driveshaft between the splined spacer and the annular ridge of the track driveshaft. In such embodiments, the braking system may include a bearing assembly positioned about the track driveshaft between the splined spacer and the annular sleeve. In certain embodiments, the third material may have a higher hardness than the first material. For example, the first material may be aluminum and the third material may be steel. In addition, the second material may be steel.

In a second aspect, the present disclosure is directed to a snowmobile. The snowmobile includes a chassis with a prime mover that is coupled to the chassis. A track driveshaft receives rotational energy from the prime mover. The track driveshaft has an outer spline and is formed from a first material. A splined spacer has an inner spline and an outer spline. The inner spline of the splined spacer forms a splined connection with the outer spline of the track driveshaft such that the splined spacer is coaxially positioned about the track driveshaft. A brake rotor has an inner spline that forms a splined connection with the outer spline of the splined spacer. The splined spacer is formed from a second material that is different from the first material.

In some embodiments, the splined spacer may be axially sized to allow axial movement of the brake rotor relative to the track driveshaft. In certain embodiments, the inner spline of the brake rotor may have an axial length X and the splined spacer may have an axial length Y wherein, X<Y. In some embodiments, a caliper assembly may be operably associated with the brake rotor with a bearing assembly rotatably coupling the caliper assembly to the track driveshaft and with an annular nut threadably coupled to the track driveshaft such that the splined spacer is positioned between and secured against axial movement by the bearing assembly and the annular nut and such that the brake rotor is positioned between the bearing assembly and the annular nut with the bearing assembly and the annular nut containing the axial movement of the brake rotor.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIGS. 1A-1D are schematic illustrations of a snowmobile having a braking system utilizing a multi-material track driveshaft assembly and a forged brake rotor in accordance with embodiments of the present disclosure;

FIGS. 2A-2C are various views of a powertrain for a snowmobile in accordance with embodiments of the present disclosure;

FIGS. 3A-3E are various views of a multi-material track driveshaft assembly utilized in a braking system for a snowmobile in accordance with embodiments of the present disclosure;

FIGS. 4A-4C are various views of a splined spacer for a multi-material track driveshaft assembly in accordance with embodiments of the present disclosure;

FIGS. 5A-5C are various views of a multi-material track driveshaft assembly utilized in a braking system for a snowmobile in accordance with embodiments of the present disclosure;

FIGS. 6A-6E are various views of a forged brake rotor utilized in a braking system for a snowmobile in accordance with embodiments of the present disclosure;

FIGS. 7A-7B are cross-sectional views of a disc-and-caliper braking system for a snowmobile in which a forged brake rotor rotates between the brake pads of a caliper assembly in accordance with embodiments of the present disclosure; and

FIGS. 8A-8B are flowcharts of various methods for producing a forged brake rotor for a snowmobile in accordance with embodiments of the present disclosure.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, all features of an actual implementation may not be described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, and the like described herein may be positioned in any desired orientation. Thus, the use of terms such as “above,” “below,” “upper,” “lower” or other like terms to describe a spatial relationship between various components or to describe the spatial orientation of aspects of such components should be understood to describe a relative relationship between the components or a spatial orientation of aspects of such components, respectively, as the devices described herein may be oriented in any desired direction. As used herein, the term “coupled” may include direct or indirect coupling by any means, including by mere contact or by moving and/or non-moving mechanical connections.

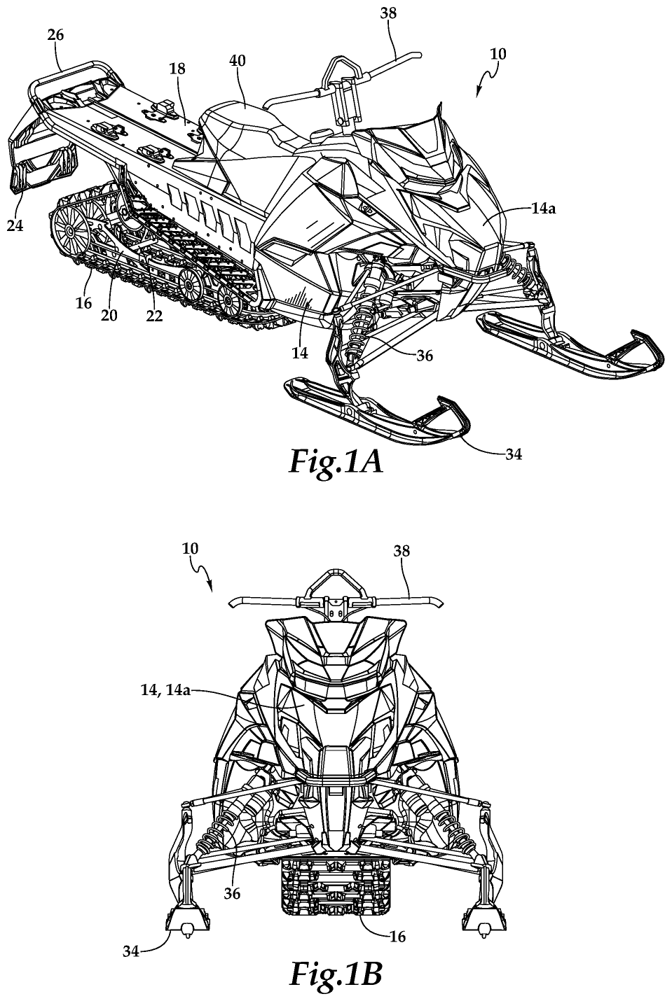

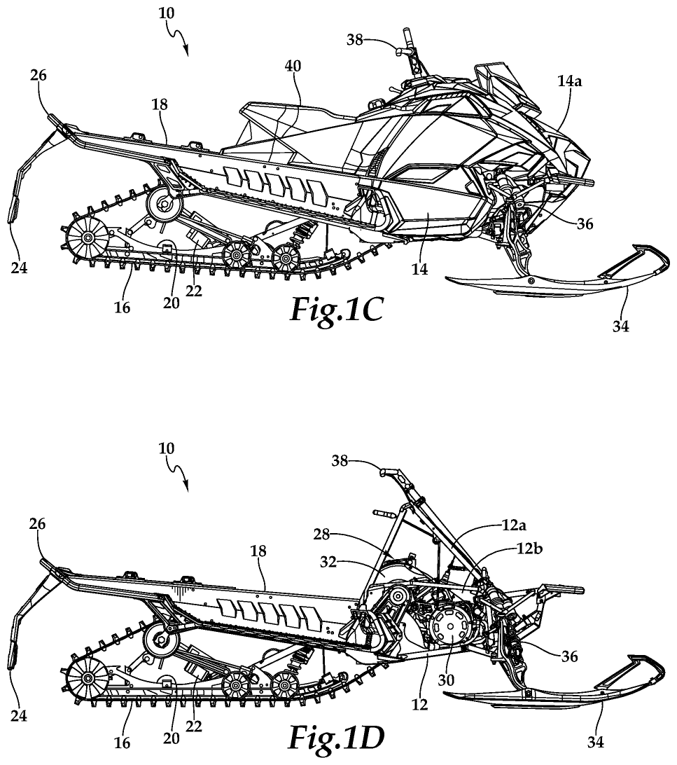

Referring to FIGS. 1A-1D in the drawings, a land vehicle depicted as a snowmobile having a braking system utilizing a multi-material track driveshaft assembly and a forged brake rotor is schematically illustrated and generally designate 10. Structural support for snowmobile 10 is provided by chassis 12, on or around which the various components of snowmobile 10 are assembled. Chassis 12 includes a forward frame assembly 12a formed from interconnected tube members. One or more shrouds 14 cover and protect the various components of snowmobile 10 including parts of chassis 12. For example, front shroud 14a shields underlying componentry from snow and shields the operator of snowmobile 10 from oncoming terrain and cold air during operation. Shrouds 14 have been removed in FIG. 1D to illustrate underlying components of snowmobile 10 including chassis 12. A drive track 16 at least partially disposed within a tunnel 18 is in contact with the ground to provide ground propulsion for snowmobile 10. Drive track 16 is supported by a track frame 20 having an internal suspension 22. Track frame 20 may be coupled to forward frame assembly 12a via a swing arm having a coil spring, a rigid strut, a torsion spring, an elastomeric member or any other suitable coupling configuration. In alternative embodiments, drive track 16 may instead be a wheel or tire. A rear flap 24 deflects snow emitted by drive track 16. A lift handle 26 may be used to lift the aft end of snowmobile 10.

A powertrain 28 including a prime mover 30 and a continuously variable transmission 32 is coupled to chassis 12 and provides rotational energy to rotate drive track 16 around track frame 20. Prime mover 30 may reside in a bay 12b formed within forward frame assembly 12a of chassis 12. While prime mover 30 is depicted as an engine such as a two-stroke engine or a four-stroke engine, in other embodiments prime mover 30 may be an electric motor. In embodiments in which prime mover 30 is an engine, the engine may be naturally aspirated or may include a power adder such as a supercharger or a turbocharger. The engine may be fuel injected or include a carburetor. Transmission types other than a continuously variable transmission may alternatively be used to control the rotational energy provided to drive track 16. In some implementations including embodiments in which prime mover 30 is an electric motor, rotational energy may be provided to drive track 16 without the need for a transmission or gearbox. Skis 34 and a front suspension assembly 36 provide front end support for snowmobile 10. Skis 34 are interconnected to handlebars 38, which are used by an operator to steer snowmobile 10 in a leftward or rightward direction. When handlebars 38 are rotated, skis 34 responsively pivot to turn snowmobile 10. The operator controls snowmobile 10 from a seat 40 atop tunnel 18 and behind handlebars 38.

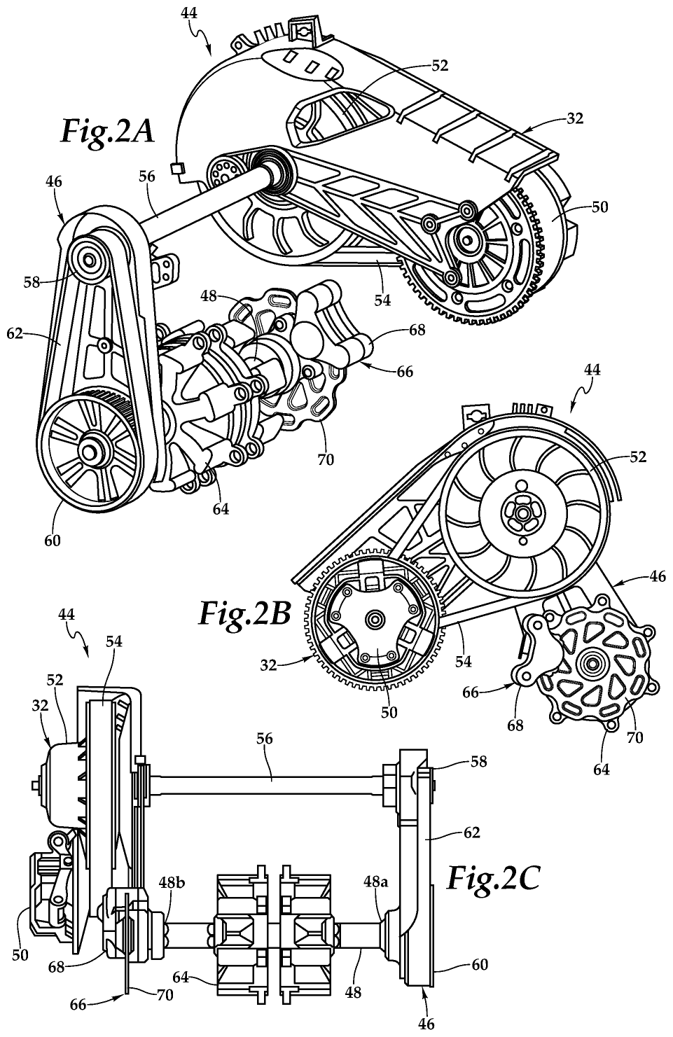

Referring additionally to FIGS. 2A-2C in the drawings, a drivetrain portion of powertrain 28 is depicted in additional detail as drivetrain 44 including continuously variable transmission 32, a belt drive subsystem 46 and a track driveshaft assembly 48. The output of prime mover 30 is received as rotational energy by primary clutch 50 via a driveshaft (not shown). Primary clutch 50 is connected to a secondary clutch 52 by a belt 54 such as a V-belt to form continuously variable transmission 32, which transmits the rotational energy received from prime mover 30 to a jack shaft 56. Primary clutch 50 and secondary clutch 52 each include a stationary sheave and a moveable sheave with belt 54 pinched therebetween. As the speed of prime mover 30 increases or decreases, the moveable sheaves move toward or away from the stationary sheaves to selectively alter the effective gear ratio of continuously variable transmission 32. Belt drive subsystem 46 includes a top drive sprocket 58 that receives rotational energy from secondary clutch 52 via jack shaft 56. Belt drive subsystem 46 also includes a bottom drive sprocket 60 connected to top drive sprocket 58 via a belt 62 to receive rotational energy therefrom. In some embodiments, belt drive subsystem 46 may be coupled to forward frame assembly 12a, tunnel 18 or other portions of snowmobile 10. One end 48a of track driveshaft assembly 48 is coupled to bottom drive sprocket 60 of belt drive subsystem 46, from which rotational energy is received. In this manner, track driveshaft assembly 48 receives rotational energy from prime mover 30 via continuously variable transmission 32 and belt drive subsystem 46. In some embodiments, drivetrain 44 may include additional gearboxes to permit an operator of snowmobile 10 to shift between forward, reverse, neutral and low gear positions.

Drive track engagement sprockets 64 are fixedly coupled near the center of track driveshaft assembly 48. Drive track engagement sprockets 64 engage cogs or other features on the inside of drive track 16 to provide rotational energy from track driveshaft assembly 48 to drive track 16. A disc-and-caliper braking system 66 is located at end 48b of track driveshaft assembly 48 opposite of track driveshaft assembly end 48a coupled to belt drive subsystem 46. Braking system 66 includes a caliper assembly 68 and a forged brake rotor 70, both of which are coupled to track driveshaft assembly 48. The brake pads of caliper assembly 68 press upon forged brake rotor 70 to slow or stop track driveshaft assembly 48, thereby slowing or stopping snowmobile 10. In accordance with the illustrative embodiments, track driveshaft assembly 48 is a multi-material driveshaft assembly having components utilized by both drivetrain 44 and braking system 66, and thus may be considered to be a part of both drivetrain 44 and braking system 66.

It should be appreciated that snowmobile 10 is merely illustrative of a variety of vehicles that can implement the embodiments disclosed herein. Indeed, track driveshaft assembly 48 and braking system 66 including forged brake rotor 70 may be implemented on any ground-based vehicle. Other vehicle implementations can include motorcycles, snow bikes, all-terrain vehicles (ATVs), utility vehicles, recreational vehicles, scooters, automobiles, mopeds and the like. As such, those skilled in the art will recognize that track driveshaft assembly 48 and braking system 66 including forged brake rotor 70 can be integrated into a variety of vehicle configurations. It should be appreciated that even though ground-based vehicles are particularly well-suited to implement the embodiments of the present disclosure, airborne vehicles and devices such as aircraft can also implement the embodiments.

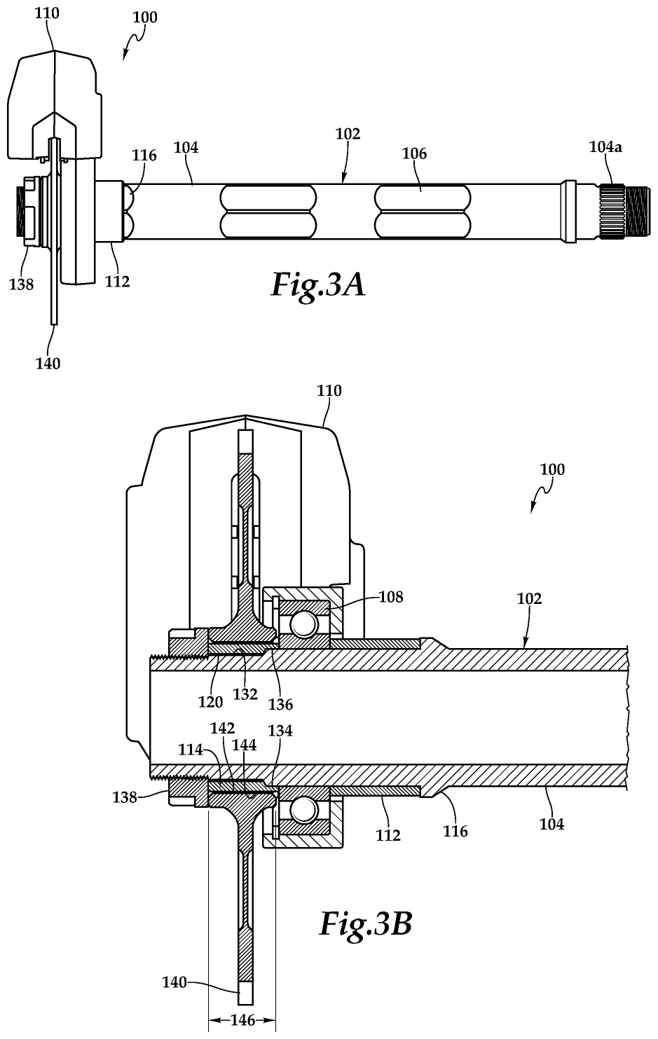

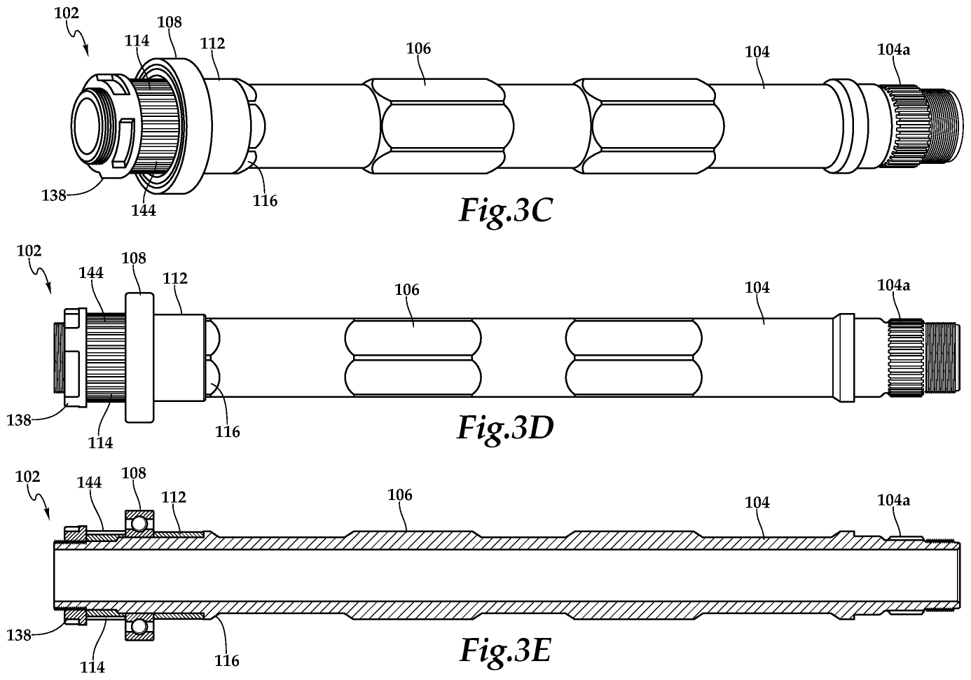

Referring to FIGS. 3A-3E in the drawings, a braking system that utilizes components of a multi-material track driveshaft assembly is schematically illustrated and generally designated 100. The driveshafts on which current disc-and-caliper braking systems act are often formed from aluminum to reduce part weight. Aluminum driveshaft components that interface with a vehicle's braking system may exhibit greater wear, shorter lifespans and generally lower performance. For example, aluminum splines that engage a brake rotor may be susceptible to fretting of the spline teeth, which, if left unchecked, results in a free spinning brake rotor. To address these and other issues with current driveshafts, track driveshaft assembly 102 includes components formed from different materials to provide both the weight reduction benefits of lightweight materials such as aluminum as well as the strength characteristics of harder materials such as steel.

Track driveshaft assembly 102 includes a track driveshaft 104 on which sprocket driving features 106 are formed. Drive track engagement sprockets such as drive track engagement sprockets 64 in FIGS. 2A-2C are fitted onto sprocket driving features 106. End 104a of track driveshaft 104 is coupled to another component of a powertrain such as belt drive subsystem 46 in FIGS. 2A-2C to receive rotational energy therefrom. Track driveshaft assembly 102 includes a bearing assembly 108 that is depicted as a ball bearing assembly. Caliper assembly 110 of braking system 100 is rotatably coupled to track driveshaft 104 via bearing assembly 108. Bearing assembly 108, and therefore caliper assembly 110, is held in place axially along track driveshaft 104 by an annular sleeve 112 and a splined spacer 114, both of which are coupled coaxially to track driveshaft 104. Sleeve 112 is positioned inboard of bearing assembly 108, which is inboard of splined spacer 114 such that sleeve 112 and splined spacer 114 are on opposite sides of bearing assembly 108. Sleeve 112 abuts an inboard ridge 116 formed on track driveshaft 104 by one or more radially increased features on the exterior of track driveshaft 104. In some embodiments, sleeve 112 may provide a hardened surface for contact with a tunnel seal assembly that prevents snow, water and other debris from exiting the tunnel and impacting the operation of braking system 100 and in particular the operation of bearing assembly 108.

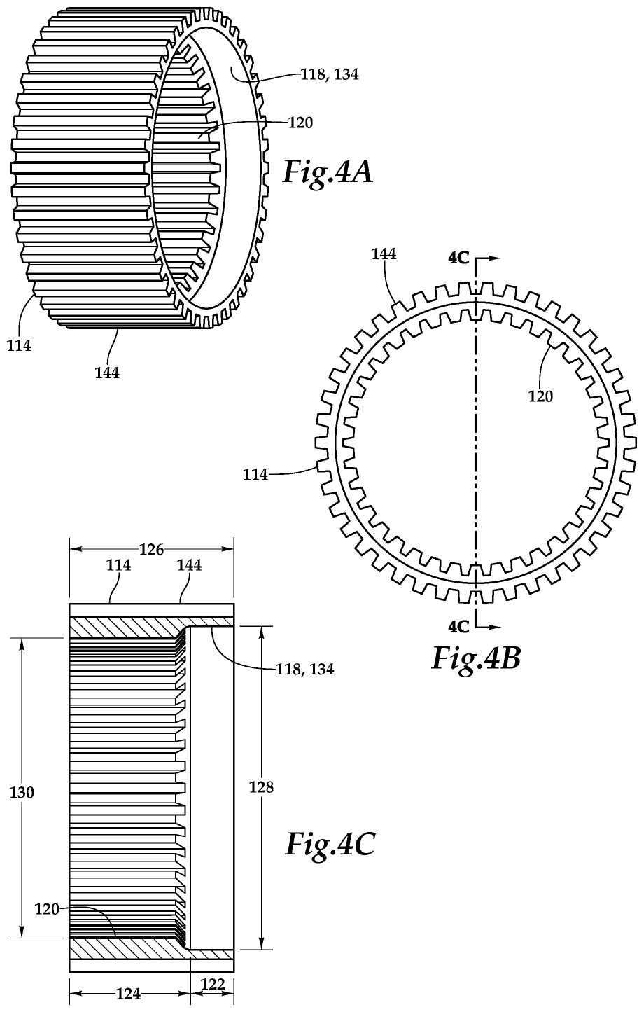

Referring to FIGS. 4A-4C in conjunction with FIGS. 3A-3E, the inner surface of splined spacer 114 forms a smooth inner nonsplined portion 118 inboard of an inner spline 120. Axial length 122 of inner nonsplined portion 118 and axial length 124 of inner spline 120 are each less than axial length 126 of splined spacer 114. Additionally, axial length 122 of inner nonsplined portion 118 is less than axial length 124 of inner spline 120, although in other embodiments axial length 122 of inner nonsplined portion 118 may be greater than axial length 124 of inner spline 120. Splined spacer 114 has a nonuniform inner diameter. More specifically, inner diameter 128 of inner nonsplined portion 118 is greater than inner diameter 130 of inner spline 120, although the reverse may be true in other embodiments.

Referring back to FIGS. 3A-3E, inner spline 120 of splined spacer 114 forms a splined connection with an outer spline 132 of track driveshaft 104 outboard of bearing assembly 108. Inner nonsplined portion 118 forms an annular socket 134 with inner diameter 128 that is configured to receive an annular shoulder 136 of track driveshaft 104 therein. A close fit between socket 134 and shoulder 136 reinforces the coaxial relationship between splined spacer 114 and track driveshaft 104, as relying on only a splined connection may introduce misalignment between the components during operation. In addition, socket 134 extends in the inboard direction to secure bearing assembly 108 in a fixed axial position, with the inboard side of splined spacer 114 abutting the outboard side of bearing assembly 108. Internal threads of an annular nut 138 form a threaded connection with external threads positioned on the outboard end of track driveshaft 104 to axially secure and lock splined spacer 114 and bearing assembly 108 into place, with splined spacer 114 interposed between nut 138 and bearing assembly 108.

Braking system 100 includes brake rotor 140 having an inner spline 142 that forms a splined connection with an outer spline 144 of splined spacer 114. Splined spacer 114 is axially sized to allow axial movement of brake rotor 140 relative to track driveshaft 104. Such axial movement is possible because axial length 126 of outer spline 144 is greater than axial length 146 of brake rotor inner spline 142, which allows brake rotor 140 to float and self-align between the brake pads of caliper assembly 110 for improved brake performance. While nut 138 secures splined spacer 114 against bearing assembly 108, locking both into place, brake rotor inner spline 142 is not rigidly locked into place by nut 138 even though it is interposed between nut 138 and bearing assembly 108. Instead, nut 138 and bearing assembly 108 contain the axial movement of brake rotor inner spline 142. Thus, splined spacer 114 locks bearing assembly 108 axially while maintaining a set distance within which brake rotor 140 may float. Splined spacer 114 provides a slight gap on both sides of a centered brake rotor inner spline 142 to allow axial float across outer spline 144 of splined spacer 114 between nut 138 and bearing assembly 108. Allowing axial movement of brake rotor 140 accommodates bending and flexing of track driveshaft 104, as may happen with more flexible metals such as aluminum. In one non-limiting example, the difference between axial length 146 of inner spline 142 of brake rotor 140 and axial length 126 of outer spline 144 of splined spacer 114 is in a range between 0.5 and 3 millimeters. In another non-limiting example, brake rotor 140 is permitted to float axially in a range between 1 and 2 millimeters.

The various components of track driveshaft assembly 102 are formed from different materials depending upon their function. In particular, splined spacer 114 is formed from a different material than track driveshaft 104. Splined spacer 114 may be formed from a material having a higher hardness, or durometer, than the material from which track driveshaft 104 is formed to improve the engagement of the splined connection between splined spacer 114 and brake rotor 140. In one non-limiting example, splined spacer 114 may be formed from steel and track driveshaft 104 may be formed from aluminum. The harder material of splined spacer 114 helps to prevent fretting from occurring as a result of the axial movement of brake rotor inner spline 142 relative to outer spline 144 of splined spacer 114, and incurs less of a weight penalty than forming the entirety of track driveshaft assembly 102 from a hard and heavy material such as steel. In some embodiments, sleeve 112 may be formed from the same material as splined spacer 114 such as steel. It will be appreciated by one of ordinary skill in the art that any combination of the various features of multi-material track driveshaft assembly 102 described herein may be utilized on any driveshaft in a vehicle, and is therefore not limited to driveshafts connected to a drive track such as drive track 16 in FIGS. 1A-1D.

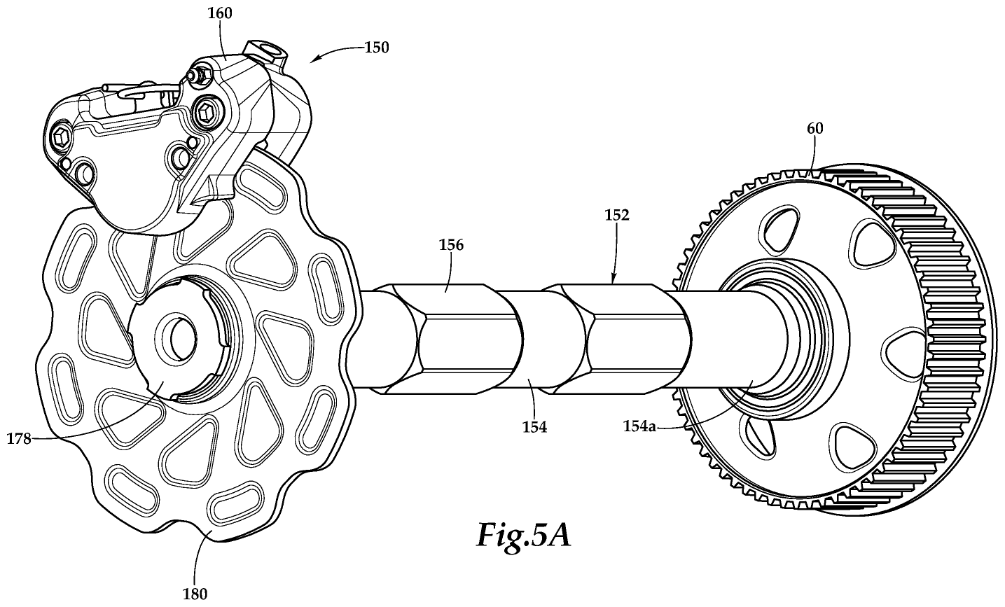

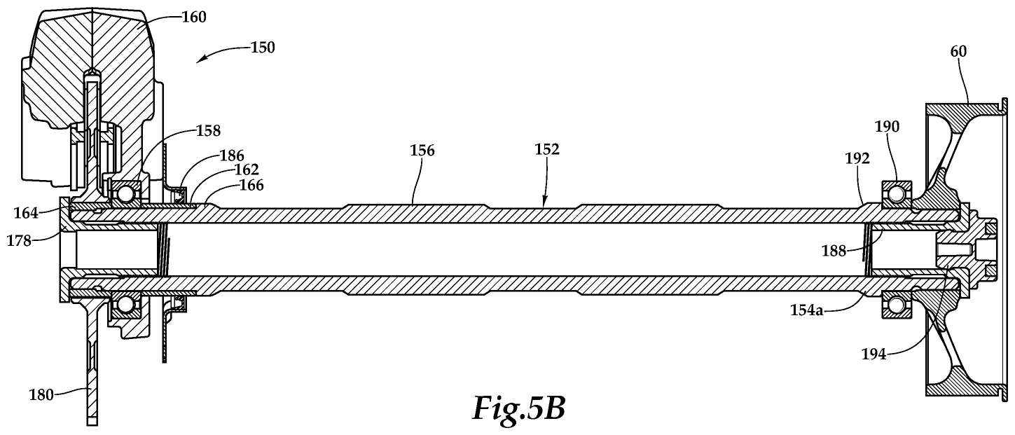

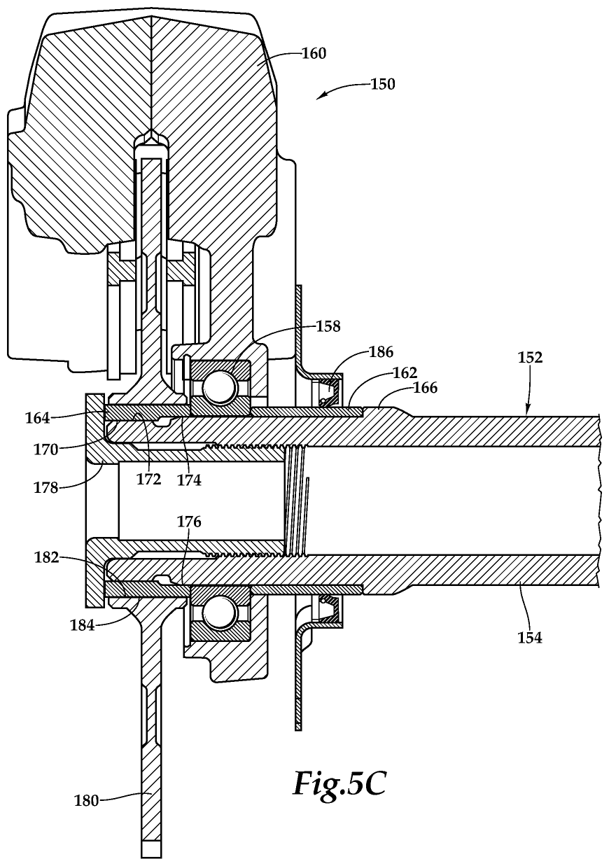

Referring to FIGS. 5A-5C in the drawings, a braking system that utilizes components of a multi-material track driveshaft assembly is schematically illustrated and generally designated 150. A track driveshaft assembly 152 includes a track driveshaft 154 on which sprocket driving features 156 are formed. Drive track engagement sprockets such as drive track engagement sprockets 64 in FIGS. 2A-2C are fitted onto sprocket driving features 156. End 154a of track driveshaft 154 is coupled to a drive sprocket such as bottom drive sprocket 60 of belt drive subsystem 46 in FIGS. 2A-2C to receive rotational energy therefrom. Track driveshaft assembly 152 includes a bearing assembly 158. A caliper assembly 160 of braking system 150 is rotatably coupled to track driveshaft 154 via bearing assembly 158. Bearing assembly 158, and therefore caliper assembly 160, is held in place axially along track driveshaft 154 by an annular sleeve 162 and a splined spacer 164, both of which are coupled coaxially to track driveshaft 154. Sleeve 162 is inboard of bearing assembly 158, which is inboard of splined spacer 164 such that sleeve 162 and splined spacer 164 are on opposite sides of bearing assembly 158. Sleeve 162 abuts an inboard ridge 166 formed by track driveshaft 154.

The inner surface of splined spacer 164 includes an inner spline 170 that forms a splined connection with an outer spline 172 of track driveshaft 154 outboard of bearing assembly 158. The inner surface of splined spacer 164 also includes an annular socket 174 that is inboard of inner spline 170. Annular socket 174 is received by an annular shoulder 176 of track driveshaft 154 outboard of bearing assembly 158. A close fit between socket 174 and shoulder 176 reinforces the coaxial relationship between splined spacer 164 and track driveshaft 154 as discussed herein. In addition, socket 174 extends in the inboard direction to secure bearing assembly 158 in a fixed axial position, with the inboard side of splined spacer 164 abutting the outboard side of bearing assembly 158. External threads along the shaft of an annular nut 178 form a threaded connection with internal threads positioned within track driveshaft 154 to axially secure and lock splined spacer 164 and bearing assembly 158 into place, with splined spacer 164 interposed between the head of nut 178 and bearing assembly 158.

Braking system 150 includes brake rotor 180 having an inner spline 182 that forms a splined connection with an outer spline 184 of splined spacer 164. Splined spacer 164 is axially sized to allow axial movement of brake rotor 180 relative to track driveshaft 154. As discussed herein, such axial movement is possible because axial length of outer spline 184 is greater than axial length of inner spline 182, which allows brake rotor 180 to float and self-align between the brake pads of caliper assembly 160 for improved brake performance. While nut 178 secures splined spacer 164 against bearing assembly 158, locking both into place, inner spline 182 is not rigidly locked into place by nut 178 even though it is interposed between nut 178 and bearing assembly 158. Instead, nut 178 and bearing assembly 158 contain the axial movement of brake rotor inner spline 182. Thus, splined spacer 164 locks bearing assembly 158 axially while maintaining a set distance within which brake rotor 180 may float. Splined spacer 164 provides a slight gap on both sides of a centered brake rotor inner spline 182 to allow axial float across outer spline 184 of splined spacer 164 between nut 178 and bearing assembly 158. Allowing axial movement of brake rotor 180 accommodates bending and flexing of track driveshaft 154, as may happen with more flexible metals such as aluminum.

A tunnel seal assembly 186 is operably associated with track driveshaft 154 and is positioned such that the seal element of tunnel seal assembly 186 contacts the outer surface of sleeve 162. Tunnel seal assembly 186 tends to prevent snow, water and other debris from exiting the tunnel and impacting the operation of braking system 150 and in particular the operation of bearing assembly 158. External threads along the shaft of an annular nut 188 form a threaded connection with internal threads positioned within track driveshaft 154 to axially secure drive sprocket 60 to track driveshaft 154. In the illustrated embodiment, nut 188 abuts an outboard surface of drive sprocket 60, an inboard surface of drive sprocket 60 abuts an outboard side of bearing assembly 190 and an inboard side of bearing assembly 190 abut an outboard side of ridge 192 such that axial movement of drive sprocket 60 and bearing assembly 190 relative to track driveshaft 154 is prevented. An inner spline of drive sprocket 60 forms a splined connection with an outer spline of track driveshaft 154. Nut 188 and nut 178 may be identical part numbers which reduces the part count associated with braking system 150. In the illustrate embodiment, a speed sensor plug 194 is receive within the outboard end and carried by nut 188. Speed sensor plug 190 may be a component of a magnetic speed sensor system associated with the belt drive subsystem of the snowmobile.

The various components of track driveshaft assembly 152 are formed from different materials depending upon their function. In particular, sleeve 162 and splined spacer 164 are formed from a different material than track driveshaft 154. Sleeve 162 and splined spacer 164 may be formed from a material having a higher hardness, or durometer, than the material from which track driveshaft 154 is formed. In one non-limiting example, sleeve 162 and splined spacer 164 may be formed from steel and track driveshaft 154 may be formed from aluminum. The harder material of sleeve 162 prevents wear cause by rotating contact with tunnel seal assembly 186. The harder material of splined spacer 164 helps to prevent fretting from occurring as a result of the axial movement of brake rotor inner spline 182 relative to outer spline 184 of splined spacer 164. The use of the harder material for sleeve 162 and splined spacer 164 incurs less of a weight penalty than forming the entirety of track driveshaft assembly 152 from a hard and heavy material such as steel. It will be appreciated by one of ordinary skill in the art that any combination of the various features of multi-material track driveshaft assembly 152 described herein may be utilized on any driveshaft in a vehicle, and is therefore not limited to driveshafts connected to a drive track such as drive track 16 in FIGS. 1A-1D.

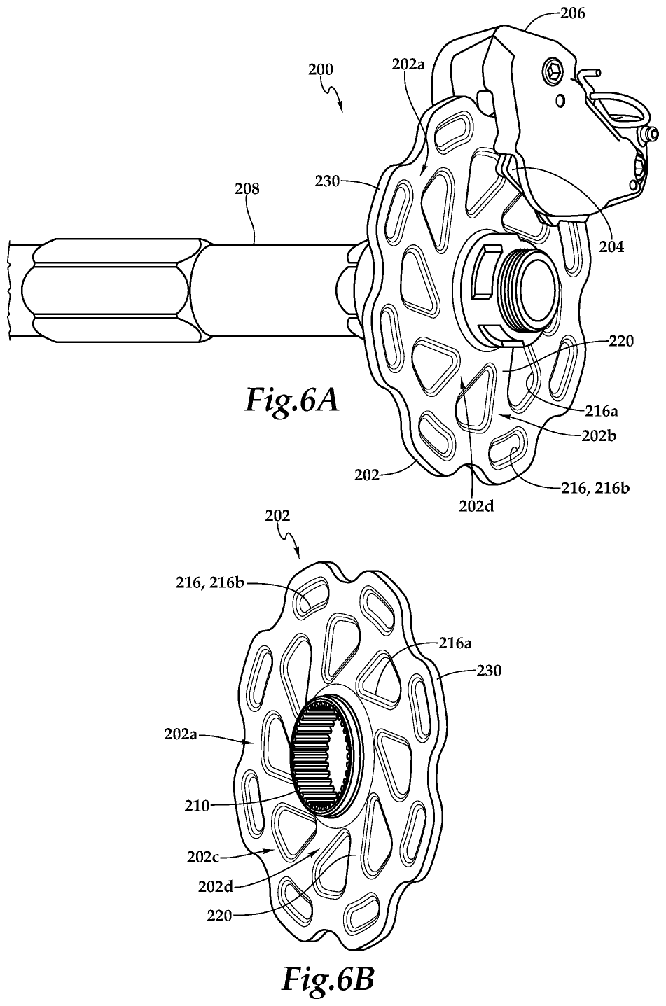

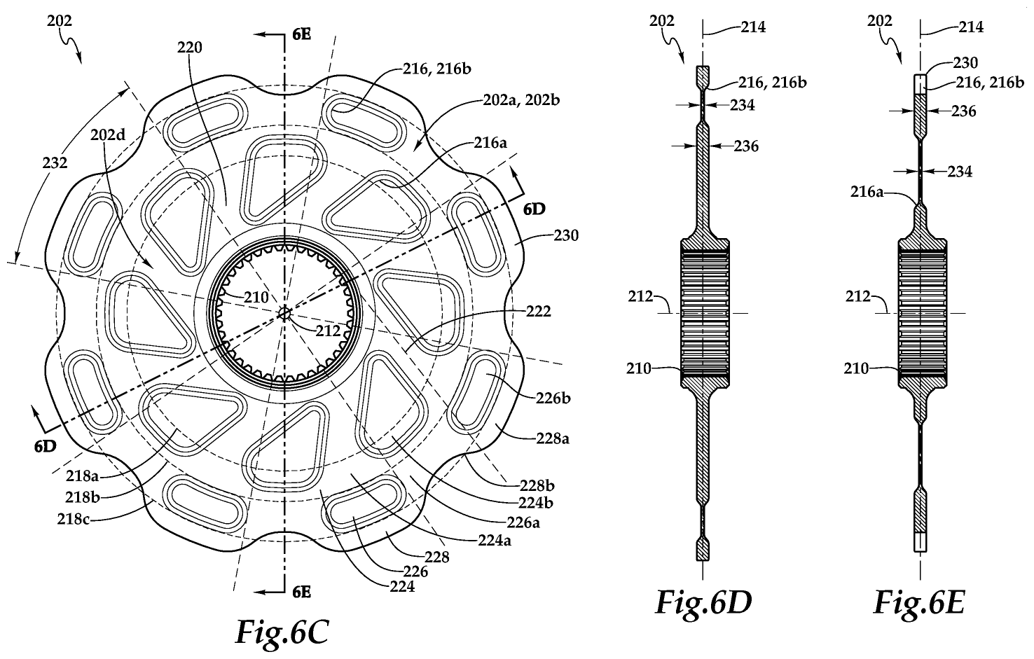

Referring to FIGS. 6A-6E in the drawings, a disc-and-caliper braking system including a forged brake rotor is schematically illustrated and generally designated 200. The brake rotor of a disc-and-caliper braking system can be a significant driver of weight and cost for a vehicle such as a snowmobile. Brake rotors are currently manufactured by first forging the initial shape of the brake rotor and then placing the brake rotor on a lathe or mill so that the brake rotor can be machined or trued up to eliminate wobble. To reduce weight, the brake rotor is then further machined to provide windows and indentations. Machining, however, is an inefficient and expensive process for reducing weight that can double or triple the manufacturing cost of the brake rotor. To address these and other issues with current brake rotors, braking system 200 includes forged brake rotor 202 having a brake scrub area 202a interposed and rotating between brake pads 204 of caliper assembly 206. Forged brake rotor 202 is coupled to driveshaft 208, which may be any driveshaft used in a vehicle, including but not limited to a track driveshaft assembly such as track driveshaft assembly 48 in FIGS. 2A-2C. Forged brake rotor 202 has inner spline 210 that forms a splined connection with an outer spline of driveshaft 208. In some embodiments, caliper assembly 206 may also be coupled to driveshaft 208. Forged brake rotor 202 rotates about a rotational axis 212 and has a plane of symmetry 214 perpendicular to rotational axis 212. FIGS. 6A and 6C show a first side 202b of forged brake rotor 202 and FIG. 6B shows a second, opposite side 202c of forged brake rotor 202.

Concentric forged indentations 216 are forged on brake scrub area 202a of each side 202b, 202c of forged brake rotor 202. Concentric forged indentations 216 include forged hub indentations 216a that straddle both brake scrub area 202a and hub area 202d of forged brake rotor 202. For visual reference, brake scrub area 202a lies outside of reference circle 218a and hub area 202d lies inside of reference circle 218a. In the illustrated embodiment, forged hub indentations 216a are each triangular in shape, although in other embodiments forged hub indentations 216a may be any shape. Forged hub indentations 216a form support spokes 220 that provide structural support for forged brake rotor 202. Support spokes 220 are slightly canted such that support spokes 220 do not radiate from a central rotational axis 212, as colinear lines 222 formed by support spokes 220 would not intersect rotational axis 212 if extended inward. Concentric forged indentations 216 also include concentric forged indentations 216b, which are radially distal relative to forged hub indentations 216a and contained entirely within brake scrub area 202a of forged brake rotor 202. Concentric forged indentations 216b approximate an oval or elongated slot shape, although concentric forged indentations 216b may be any shape.

Concentric forged indentations 216 are nonmachined indentations created using a forging process. Because forged brake rotor 202 is net forged, the overall weight of forged brake rotor 202 is reduced. Cost is also reduced since concentric forged indentations 216 do not require expensive machining processes that rely on, for example, a lathe or mill. Forged brake rotor 202 also benefits from the enhanced skin strength provided by forging processes. It will be appreciated that even though concentric forged indentations 216 are not machined, other portions of forged brake rotor 202 may be machined. For example, inner spline 210 may be broached and then turned in a machining process. In an alternative embodiment, concentric forged indentations 216 may be stamped out using a stamping tool after being forged.

As best seen in FIG. 6C, concentric forged indentations 216 form contact zones 224a, 226a, 228a and noncontact zones 224b, 226b, 228b alternatingly arranged in annular and concentric rows 224, 226, 228. For visual reference, innermost row 224 is located between reference circles 218a and 218b, middle row 226 is located between reference circles 218b and 218c and outermost row is located outside of reference circle 218c. While the illustrated embodiment shows concentric forged indentations 216 as forming three annular and concentric rows 224, 226, 228, it will be appreciated that concentric forged indentations 216 may form any number of rows such as two, four, five or more rows. Distal portions of forged hub indentations 216a form noncontact zones 224b of innermost row 224 and distal ends of support spokes 220 form contact zones 224a of innermost row 224. The outer edge of forged brake rotor 202 forms tabs 230, which protrude radially from forged brake rotor 202 and are evenly spaced circumferentially around forged brake rotor 202. Tabs 230 form contact zones 228a of outermost row 228 and the gaps between tabs 230 form noncontact zones 228b of outermost row 228. Contact zones 224a, 226a, 228a in each row 224, 226, 228 are evenly spaced circumferentially. Additionally, contact zones 224a, 226a, 228a and noncontact zones 224b, 226b, 228b alternate in a repeating manner at uniform intervals 232 around forged brake rotor 202.

Brake scrub area 202a of forged brake rotor 202 has a nonuniform axial thickness. As best seen in FIGS. 6D and 6E, which are cross-sectional views of FIG. 6C along lines 6D-6D and 6E-6E, respectively, forged hub indentations 216a and concentric forged indentations 216b, and therefore noncontact zones 224b, 226b in rows 224, 226, each have a uniform nonzero thickness 234. Contact zones 224a, 226a, 228a in rows 224, 226, 228 each have a uniform nonzero thickness 236. Uniform nonzero thickness 234 of noncontact zones 224b, 226b is less than uniform nonzero thickness 236 of contact zones 224a, 226a, 228a. In some embodiments, uniform nonzero thickness 234 of noncontact zones 224b, 226b is less than half of uniform nonzero thickness 236 of contact zones 224a, 226a, 228a. In one non-limiting example, uniform nonzero thickness 236 of contact zones 224a, 226a, 228a is in a range between 5 millimeters and 8 millimeters such as approximately 6.35 millimeters or one-quarter of an inch. In another non-limiting example, uniform nonzero thickness 234 of noncontact zones 224b, 226b is in a range between 0.5 millimeters and 3 millimeters such as 2 millimeters or one-eighth of an inch.

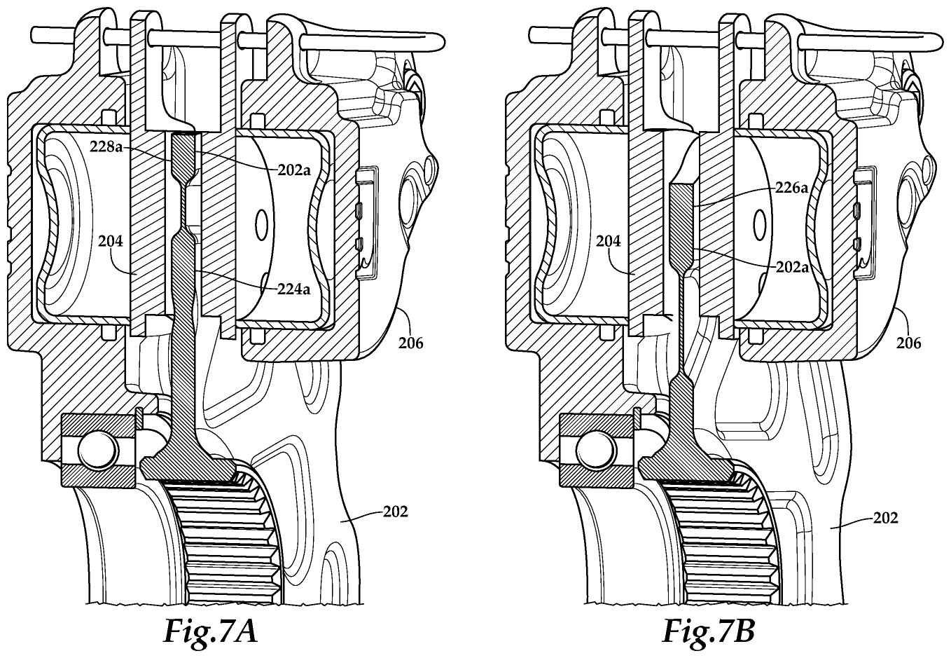

Referring additionally to FIGS. 7A-7B in the drawings, brake scrub area 202a of forged brake rotor 202 rotates between brake pads 204 of caliper assembly 206. Contact zones 224a in innermost row 224 are radially offset from contact zones 226a in middle row 226. Contact zones 224a in innermost row 224 are radially aligned with contact zones 228a in outermost row 228. Contact zones 226a in middle row 226 are radially offset from contact zones 224a, 228a in innermost and outermost rows 224, 228. Thus, as forged brake rotor 202 rotates about rotational axis 212 when brake pads 204 are applied, contact zones 224a, 228a in innermost and outermost rows 224, 228 contact the inner and outer portions of brake pads 204 as shown in FIG. 7A and contact zones 226a in middle row 226 contact the middle portion of brake pads 204 as shown in FIG. 7B. Thus, the alternating contact zones 224a, 226a, 228a of forged brake rotor 202 provide constant and alternating brake scrub area support and contact with brake pads 204 to prevent rocking and improve the wear profile of brake pads 204.

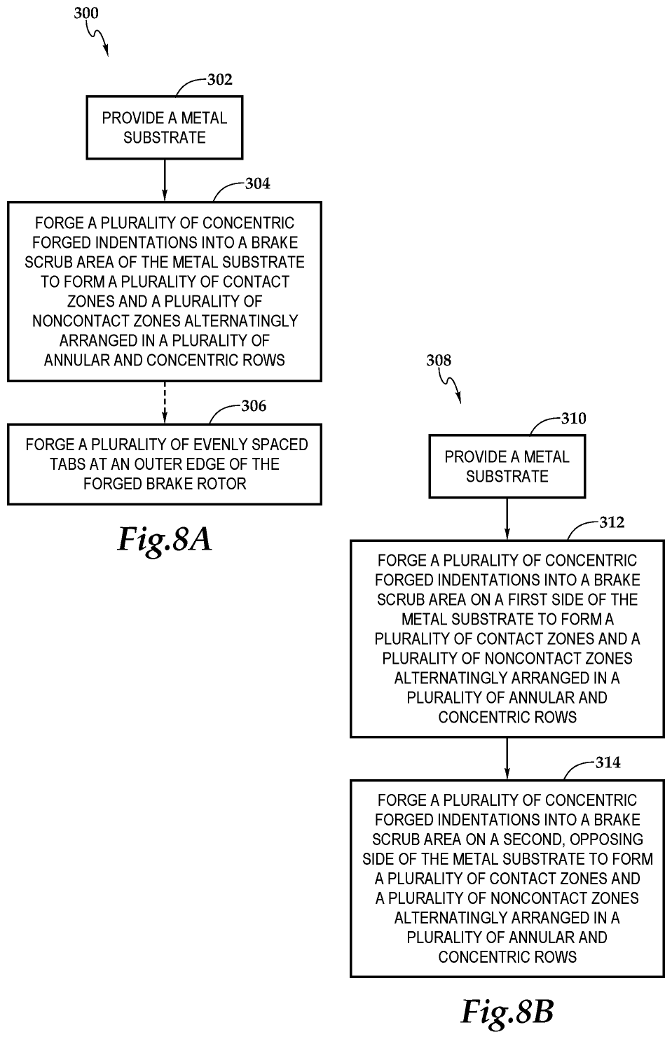

Referring to FIGS. 8A-8B in the drawings, various methods for producing a forged brake rotor for a snowmobile are depicted. In FIG. 8A, method 300 includes providing a metal substrate (step 302) and forging a plurality of concentric forged indentations into a brake scrub area of the metal substrate to form a plurality of contact zones and a plurality of noncontact zones alternatingly arranged in a plurality of annular and concentric rows (step 304). Method 300 optionally includes forging a plurality of evenly spaced tabs at an outer edge of the forged brake rotor (step 306). In some embodiments, the plurality of annular and concentric rows include first and second rows and the contact zones in the first row are offset from the contact zones in the second row. In other embodiments, the plurality of annular and concentric rows include first, second and third rows wherein the contact zones in the first and third rows are radially aligned and the contact zones in the second row are radially offset from the contact zones in the first and third rows. In embodiments that include forging a plurality of evenly spaced tabs at an outer edge of the forged brake rotor, the plurality of tabs may form the contact zones of an outermost row of the plurality of annular and concentric rows. In certain embodiments, method 300 may include forging the plurality of concentric forged indentations into the brake scrub area such that the plurality of concentric forged indentations are evenly spaced circumferentially. In some embodiments, method 300 may include forging the plurality of concentric forged indentations to have a uniform nonzero thickness. In certain embodiments, forging a plurality of concentric forged indentations into the brake scrub area of the metal substrate includes forging a plurality of forged hub indentations into the metal substrate. After the forged brake rotor has been produced using method 300, the brake rotor may then be installed in the braking system of a snowmobile.

In FIG. 8B, method 308 includes providing a metal substrate (step 310), forging a plurality of concentric forged indentations into a brake scrub area on a first side of the metal substrate to form a plurality of contact zones and a plurality of noncontact zones alternatingly arranged in a plurality of annular and concentric rows (step 312) and forging a plurality of concentric forged indentations into a brake scrub area on a second, opposing side of the metal substrate to form a plurality of contact zones and a plurality of noncontact zones alternatingly arranged in a plurality of annular and concentric rows (step 314). In some embodiments, the forged brake rotor produced by method 308 may have the same pattern of concentric forged indentations on both sides of the forged brake rotor and have a plane of symmetry perpendicular to the rotational axis of the forged brake rotor. After the forged brake rotor has been produced using method 308, the brake rotor may then be installed in the braking system of a snowmobile.

The flowcharts in the different depicted embodiments illustrate the architecture, functionality and operation of some possible implementations of apparatus, methods or computer program products. In this regard, each block in the flowchart may represent one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated. For example, numerous combinations of the features disclosed herein will be apparent to persons skilled in the art including the combining of features described in different and diverse embodiments, implementations, contexts, applications and/or figures. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

What is claimed is:

1. A braking system for a snowmobile, the braking system having a brake rotor with an inner spline, the braking system comprising:
a track driveshaft having an outer spline, the track driveshaft formed from a first material; and
a splined spacer having an inner spline and an outer spline, the inner spline of the splined spacer forming a splined connection with the outer spline of the track driveshaft such that the splined spacer is coaxially positioned about the track driveshaft, the outer spline of the splined spacer configured to form a splined connection with the inner spline of the brake rotor, the splined spacer formed from a second material;
wherein, the first material is different from the second material.

2. The braking system as recited in claim 1 wherein, the second material has a higher hardness than the first material.

3. The braking system as recited in claim 1 wherein, the first material is aluminum and the second material is steel.

4. The braking system as recited in claim 1 wherein, the track driveshaft has an annular shoulder positioned inboard of the outer spline of the track driveshaft;
wherein, the splined spacer has an annular socket positioned inboard of the inner spline of the splined spacer; and
wherein, the annular socket of the splined spacer is received by the annular shoulder of the track driveshaft.

5. The braking system as recited in claim 4 wherein, the annular socket of the splined spacer and the annular shoulder of the track driveshaft have a close fitting relationship.

6. The braking system as recited in claim 4 wherein, the splined spacer has an axial length X, the inner spline of the splined spacer has an axial length Y and the annular socket of the splined spacer has an axial length Z; and
wherein, Y<X, Z<X and Z<Y.

7. The braking system as recited in claim 4 further comprising an annular nut having internal threads;
wherein, the track driveshaft has external threads positioned outboard of the outer spline of the track driveshaft; and
wherein, the internal threads of the annular nut have a threaded connection with the external threads of the track driveshaft such that the annular nut prevents axial movement of the splined spacer relative to the track driveshaft.

8. The braking system as recited in claim 4 further comprising an annular nut having external threads;
wherein, the track driveshaft has internal threads positioned inboard of the outer spline of the track driveshaft; and
wherein, the external threads of the annular nut have a threaded connection with the internal threads of the track driveshaft such that the annular nut prevents axial movement of the splined spacer relative to the track driveshaft.

9. The braking system as recited in claim 8 wherein, the annular nut has a head and a shaft;
wherein, the shaft includes the external threads and is received inside the track driveshaft; and
wherein, the head is positioned outboard of the track driveshaft and in contact with the splined spacer.

10. The braking system as recited in claim 8 wherein, the track driveshaft has a radially reduced external section positioned between the outer spline of the track driveshaft and the annular shoulder of the track driveshaft.

11. The braking system as recited in claim 10 wherein, the internal threads of the track driveshaft are positioned inboard of the radially reduced external section of the track driveshaft.

12. The braking system as recited in claim 4 further comprising an annular sleeve formed from a third material;
wherein, the track driveshaft has an annular ridge positioned inboard of the annular shoulder of the track driveshaft; and
wherein, the annular sleeve is coaxially positioned about the track driveshaft between the splined spacer and the annular ridge of the track driveshaft.

13. The braking system as recited in claim 12 further comprising a bearing assembly positioned about the track driveshaft between the splined spacer and the annular sleeve.

14. The braking system as recited in claim 12 wherein, the third material has a higher hardness than the first material.

15. The braking system as recited in claim 12 wherein, the first material is aluminum and the third material is steel.

16. The braking system as recited in claim 12 wherein, the first material is aluminum, the second material is steel and the third material are steel.

17. A snowmobile comprising:
a chassis;
a prime mover coupled to the chassis;
a track driveshaft having an outer spline, track driveshaft receiving rotational energy from the prime mover, the track driveshaft formed from a first material;
a splined spacer having an inner spline and an outer spline, the inner spline of the splined spacer forming a splined connection with the outer spline of the track driveshaft such that the splined spacer is coaxially positioned about the track driveshaft, the splined spacer formed from a second material; and
a brake rotor having an inner spline forming a splined connection with the outer spline of the splined spacer;
wherein, the first material is different from the second material.

18. The snowmobile as recited in claim 17 wherein, the splined spacer is axially sized to allow axial movement of the brake rotor relative to the track driveshaft.

19. The snowmobile as recited in claim 17 wherein the inner spline of the brake rotor has an axial length X and the splined spacer has an axial length Y; and
wherein, X<Y.

20. The snowmobile as recited in claim 17 further comprising:
a caliper assembly operably associated with the brake rotor,
a bearing assembly rotatably coupling the caliper assembly to the track driveshaft; and
an annular nut threadably coupled to the track driveshaft;
wherein, the splined spacer is positioned between and secured against axial movement by the bearing assembly and the annular nut; and
wherein, the brake rotor is positioned between the bearing assembly and the annular nut such that the bearing assembly and the annular nut contain the axial movement of the brake rotor.
